(19) United States
(12) Patent Application Publication
(10) Pub. No.: US 2026/0151702 A1
(43) Pub. Date: Jun. 4, 2026

(54) PICTURE STREAMING METHOD AND APPARATUS, ELECTRONIC DEVICE, COMPUTER-READABLE STORAGE MEDIUM, AND COMPUTER PROGRAM PRODUCT

(71) Applicant: TENCENT TECHNOLOGY (SHENZHEN) COMPANY LIMITED, Shenzhen (CN)

(72) Inventors: Mingxing REN, Shenzhen (CN); Yingkun XI, Shenzhen (CN)

(21) Appl. No.: 19/456,831

(22) Filed: Jan. 22, 2026

Related U.S. Application Data
(63) Continuation of application No. PCT/CN2024/137785, filed on Dec. 9, 2024.

(30) Foreign Application Priority Data
Jan. 18, 2024 (CN) 202410072006.3

(51) Int. Cl. A63F 13/52; G06F 3/01; G06T 9/00; G06T 15/04; G06T 15/20

(52) U.S. Cl. CPC A63F 13/52; G06F 3/012; G06F 3/013; G06T 9/00; G06T 15/04; G06T 15/20; A63F 2300/8082

(57) ABSTRACT

A picture streaming method performed by an electronic device includes obtaining texture data of a virtual scene picture of a target application based on a target streaming manner selected from a plurality of streaming manners. The target application is configured to render the virtual scene picture. The method further includes encoding the texture data to obtain a texture encoding result, and transmitting the texture encoding result to a head mounted display device. The texture encoding result is configured for triggering the head mounted display device to decode the texture encoding result to obtain the texture data, and display the virtual scene picture based on the texture data.

### CROSS-REFERENCE TO RELATED APPLICATIONS

This application is a continuation of International Application No. PCT/CN 2024/137785, filed on Dec. 9, 2024, which is based upon and claims priority to Chinese Patent Application No. 202410072006.3, filed on Jan. 18, 2024, the entire contents of both of which are incorporated herein by reference.

### FIELD OF THE TECHNOLOGY

This application relates to the field of virtual reality technologies, and in particular, to a picture streaming method and apparatus, an electronic device, a computer-readable storage medium, and a computer program product.

### BACKGROUND OF THE DISCLOSURE

With continuous development of applications related to virtual scene, more hardware manufacturers start to use openxr rendering and interaction protocols to display and interact with virtual pictures. For example, there are already a plurality of hardware manufacturers embedding head mounted display (HMD) software apparatuses developed based on openxr in hardware devices, to adapt rendering and game controller interaction of the manufacturers'own hardware.

In a related technology, many virtual reality applications on a personal computer (PC) end stream pictures and sounds to an HMD end in a streaming manner. However, the related technology lacks a solution of streaming a picture of the virtual reality application on the PC end to a head mounted display based on an openxr protocol.

### SUMMARY

In accordance with the disclosure, there is provided a picture streaming method performed by an electronic device and including obtaining texture data of a virtual scene picture of a target application based on a target streaming manner selected from a plurality of streaming manners. The target application is configured to render the virtual scene picture. The method further includes encoding the texture data to obtain a texture encoding result, and transmitting the texture encoding result to a head mounted display device. The texture encoding result is configured for triggering the head mounted display device to decode the texture encoding result to obtain the texture data, and display the virtual scene picture based on the texture data.

Also in accordance with the disclosure, there is provided an electronic device including a memory storing computer-executable instructions or a computer program, and a processor configured to execute the computer-executable instructions or the computer program to obtain texture data of a virtual scene picture of a target application based on a target streaming manner selected from a plurality of streaming manners. The target application is configured to render the virtual scene picture. The processor is further configured to execute the computer-executable instructions or the computer program to encode the texture data to obtain a texture encoding result, and transmit the texture encoding result to a head mounted display device. The texture encoding result is configured for triggering the head mounted display device to decode the texture encoding result to obtain the texture data, and display the virtual scene picture based on the texture data.

Also in accordance with the disclosure, there is provided a non-transitory computer-readable storage medium storing computer-executable instructions or a computer program that, when executed by a processor, causes an electronic device including the processor to obtain texture data of a virtual scene picture of a target application based on a target streaming manner selected from a plurality of streaming manners. The target application is configured to render the virtual scene picture. The computer-executable instructions or the computer program, when executed by the processor, further causes the electronic device to encode the texture data to obtain a texture encoding result, and transmit the texture encoding result to a head mounted display device. The texture encoding result is configured for triggering the head mounted display device to decode the texture encoding result to obtain the texture data, and display the virtual scene picture based on the texture data.

### BRIEF DESCRIPTION OF THE DRAWINGS

FIG. 1 is a schematic diagram showing a position and an orientation of a head mounted display according to an embodiment of this application.

FIG. 2 is a schematic flowchart of VR rendering and mobile phone Android rendering.

FIG. 3 is a schematic diagram showing an architecture of a picture streaming system according to an embodiment of this application.

FIG. 4 is a schematic diagram showing a structure of an electronic device according to an embodiment of this application.

FIG. 5 is a schematic flowchart of a picture streaming method according to an embodiment of this application.

FIG. 6 is a schematic diagram showing cross fusion of pictures of a left eye and a right eye in this application.

FIG. 7 is a schematic diagram showing a client interface of DPT according to an embodiment of this application.

FIG. 8 is a schematic diagram showing a client interface after DPT selects steamvr for streaming according to an embodiment of this application.

FIG. 9 is a schematic diagram showing a client interface after DPT selects openvr for streaming according to an embodiment of this application.

FIG. 10 is a schematic diagram showing a client interface of a game editor according to an embodiment of this application.

FIG. 11 is a schematic diagram showing a level preview of a game editor according to an embodiment of this application.

FIG. 12 is a schematic diagram showing streaming processes of openxr and steamvr according to an embodiment of this application.

FIG. 13 is a schematic flowchart of an interaction between a game side and VRClient according to an embodiment of this application.

FIG. 14 is a schematic diagram showing a rendering process of a game according to an embodiment of this application.

FIG. 15 is a schematic diagram showing a plurality of textures created by VRClient according to an embodiment of this application.

FIG. 16 is a schematic diagram showing a selection interface of a graphics rendering device of DPT according to an embodiment of this application.

FIG. 17 is a schematic diagram showing a rendering process within steamvr according to an embodiment of this application.

FIG. 18 is a schematic flowchart of steamvr streaming according to an embodiment of this application.

FIG. 19 is a schematic diagram showing textures of a left eye and a right eye after game rendering according to an embodiment of this application.

FIG. 20 is a schematic diagram showing textures of a left eye and a right eye obtained through decoding by a head mounted display according to an embodiment of this application.

FIG. 21 is a schematic diagram showing textures of a left eye and a right eye displayed on an HMD according to an embodiment of this application.

### DESCRIPTION OF EMBODIMENTS

To make the objectives, technical solutions, and advantages of this application clearer, the following describes this application in further detail with reference to the accompanying drawings. The described embodiments are not to be considered as a limitation to this application. All other embodiments obtained by a person of ordinary skill in the art without creative efforts shall fall within the protection scope of this application.

In the following description, the term “some embodiments” describes a subset of all possible embodiments. However, “some embodiments” may be same or different subsets of all the possible embodiments, and may be combined with each other when there is no conflict.

In the following description, the term “first/second/third” is only configured for distinguishing similar objects and does not represent a specific order of objects. The term “first/second/third” may be interchanged with a specific order or priority if permitted, so that embodiments of this application described here may be implemented in an order other than that illustrated or described here.

In embodiments of this application, a term “module” or “unit” refers to a computer program having a predetermined function or a part of a computer program, and operates together with other relevant parts to achieve a predetermined objective, and may be all or partially implemented by using software, hardware (such as a processing circuit or a memory), or a combination thereof. Similarly, one processor (or a plurality of processors or memories) may be configured to implement one or more modules or units. In addition, each module or unit may be a part of an overall module or unit including a function of the module or unit.

Unless otherwise defined, meanings of all technical and scientific terms used in embodiments of this application are the same as those usually understood by a person skilled in the art. Terms used in embodiments of this application are merely intended to describe objectives of embodiments of this application, but are not intended to limit this application.

Before embodiments of this application are further described in detail, a description is made on terms in embodiments of this application, and the terms involved in embodiments of this application are applicable to the following explanations.

(1) openxr is configured for image rendering and device access to a software development kit (SDK) in the field of games and virtual reality (VR). An objective thereof is to provide a unified interface, so that VR and augmented reality (AR) applications may run on a plurality of devices and platforms, and specific code does not need to be written for each system.

(2) steamvr is also referred to as openvr and a predecessor of openxr standard. steamvr is specifically designed for supporting a virtual reality head mounted display device, supports a plurality of different types of VR hardware, and allows a developer to write unified application logic for devices of different brands.

(3) d3d11 and d3d12 are graphics rendering SDKs of a Windows system and are also referred to as DirectX or Direct3D (D3D). Currently, most computer games (PC games) use d3d11, and a few new games use d3d12.

(4) Image grabbing means copying and transmitting a texture that is obtained by drawing a game completely and is usually configured for secondary rendering and video encoding.

(5) Streaming, in embodiments of this application, refers to a process in which a virtual scene picture is encoded and then transmitted to a display end for displaying. For example, in a VR game, streaming means performing audio/video encoding on pictures and sounds of a left eye and a right eye of the game and transmitting to a head mounted display side (such as a head mounted display HMD) for playing; and the head mounted display side transmits tracking data back to the game side (for example, a Windows end) for game control.

(6) Tracking data is a term in VR and mainly includes pose information of an HMD and pose information of two game controllers.

(7) Encoding generally includes two encoding manners: hardware encoding and software encoding. The hardware encoding indicates a technology of implementing fast video encoding by using computing power of a graphics processing unit (GPU), and an encoding speed of the hardware encoding is faster than that of a central processing unit (CPU). The software encoding means performing video encoding by using computing power of a CPU. Because a cache and computing power of the CPU are limited, the software encoding is not suitable for a scenario with a high resolution and a high real-time degree.

(8) VRClient, in embodiments of this application, refers to a dynamic link library and may be openvr_client.dll or openxr_client.dll. openvr_client.dll and openxr_client. dll may be separately invoked by steamvr or a game in which an openxr protocol is implemented. A main objective is to interface with a game editor. For example, operations such as controlling a rendering frame rate for game drawing, and creating a texture for the game and providing the texture for the game drawing are all performed in VRClient.

(9) A head mounted display HMD generally refers to VR glasses and sometimes refers to a helmet. In a monado SDK, a software apparatus is created for each manufacturer to interface with a hardware input (a game controller button, head tracking data, and the like), and the foregoing hardware input is written into a game editor, to implement game control.

(10) A quaternion is usually configured for representing rotation transformation of three-dimensional space and may also be considered as a three-dimensional complex region, where x, y, and z are imaginary parts, and w is a real part (where a fixed value is 1).

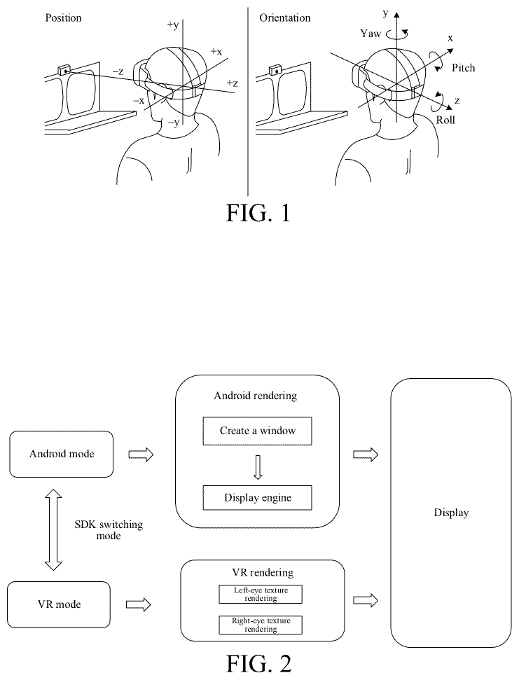

(11) Pose information includes a position and an orientation. As shown in FIG. 1, a position indicates up-down, left-right, and front-back displacements of a head mounted display. An orientation is usually also associated with a quaternion and is configured for representing an orientation of the head mounted display in space: an x-axis (pitch), a y-axis (yaw), and a z-axis (roll).

(12) monado is an open source SDK based on an openxr protocol, is an extended reality (XR) SDK developed jointly by some manufacturers, and has gradually become a standard in the VR and XR industry. After being compiled, a monado SDK may be run on an HMD, or may be run on a Windows end.

There is a still very few VR games directly installed in an HMD. Most VR games are installed on a PC end (for example, the Windows end, using the Windows end as an example in this application for description, which is also applicable to another operating system of the PC end), and pictures and sounds of the VR games are streamed to the HMD in a streaming manner for user experience. Therefore, streaming software on the Windows end is indispensable in development and running of the VR game. In a related technology, streaming software of a Windows system is not applicable to a monado open source item based on the openxr protocol. Consequently, an HMD using the monado SDK cannot provide experience of a VR application on the Windows end.

In addition, the HMD may obtain a position and an orientation of the head by using a get_tracked_pose interface. The get_tracked_pose interface is more configured for movement prediction of a helmet, and is configured for reducing a delay of an actual head movement and a picture movement. A part of a vertigo feeling generated when a user uses VR is caused by asynchronization between body and picture. Therefore, the get_tracked_pose interface is to synchronize pictures of the game and the helmet as much as possible. The HMD may further obtain positions and orientations of two eyeballs and a field of view (fov) by using a get_view_poses interface, where the field of view is determined by a hardware parameter of the HMD. However, the foregoing solution of obtaining pose information by using a plurality of interfaces is implemented on an HMD end, and there is still no solution in the related technology in which data is written in a streaming scenario, that is, there is no implementation solution of the monado SDK that can be used in the streaming scenario on the Windows end. If in the streaming scenario, the pose information of the head and the two eyes of the head mounted display is written into the game editor of the Windows end based on the foregoing logic, a very severe vertigo feeling occurs. When the user rotates the head, a surrounding scenario also rotates, causing a feeling similar to standing on a rotating disk. A normal scene is that the user rotates the head, and a surrounding scene does not need to rotate, but an object seen by two eyes moves with the eyeballs and conforms to the expectation of the brain. Motion sickness is that a movement of an object seen by the eyes cannot be consistent with rotation of head muscles, that is, does not conform to the expectation of the brain.

Game running of openxr is apparently different from game running of a mobile phone end. An openxr runtime (an XR running environment) of a particular hardware device is used as an example. As shown in FIG. 2, when the mobile phone end is not connected to an HMD, it is assumed that a game running on the mobile phone end is in an Android mode. In an Android rendering process, a window is created first, that is, a window for displaying a game picture is created, then the game picture is rendered based on a display engine, and a rendered game picture is transmitted to a display (a mobile phone interface) for displaying. When the mobile phone end is connected to the HMD, based on an SDK switching mode, game running of openxr is in a VR mode. In a VR rendering process, left-eye texture rendering and right-eye texture rendering are performed, and a rendered texture of a left eye and a rendered texture of a right eye are transmitted to the display (HMD). openxr renders two textures, a left eye and a right eye, of a display screen of VR. In a rendering process, time prediction and pose prediction are performed. In the time prediction, rendering time and screen display time of a next frame of image of the VR are predicted, and in the pose prediction, displacement coordinates of a next pose of the user are predicted based on the rendering time and the screen display time that are given by using the time prediction. For example, if the user is displaying an image appearing on the top of an object, when the user rotates the head (where the VR glasses are worn on the head), the object may still remain stationary, or move faster or slower than expected by the user. However, by using the foregoing time prediction and pose prediction, a better correspondence between an image and an object can be achieved.

Similarly, when streaming is performed on the VR game, an openxr runtime is also run in real time in the VR game on the Windows end. The openxr runtime predicts rendering time of a next frame of the VR game based on graphics card rendering and a set rendering frame rate. Because there are two openxr runtimes (an HMD and Windows), a head pose (a position and an orientation) predicted by the head mounted display cannot be accurately combined with a Windows openxr runtime (because rendering prediction time on a Windows side is calculated based on a graphics card and game logic). Therefore, after the pose information of the head and two eyes is transmitted to the get_tracked_pose interface and the get_view_poses interface of the Windows openxr runtime, an image seen by the eyes may be slightly fast-forwarded or rotated with a delay, causing a vertigo feeling.

As more manufacturers start to use monado as an implementation SDK for openxr, it is needed to develop a virtual HMD for hardware streaming based on the monado SDK. Therefore, based on at least one of the foregoing problems existing in the related technology, in embodiments of this application, a virtual HMD (XR_DirectPreview_Tool, DPT for short) apparatus is developed based on the monado SDK, to be configured for streaming of the VR game, and supports both openxr streaming and steamvr streaming, to make up for blank of a streaming function of the VR game of monado on a PC end. A picture streaming method provided in some embodiments may be applied to DPT. Based on a streaming manner in which monado SDK source code implements openxr, tracking data from the HMD is received, and texture data of the VR game after rendering is completed is encoded and then transmitted to the HMD for display.

In the picture streaming method provided in some embodiments, first, a selected streaming manner is used as a target streaming manner in response to a selection operation for a plurality of streaming manners. Next, texture data of a virtual scene picture of a target application is obtained based on the target streaming manner, the target application being configured to render the virtual scene picture. Then, the texture data is encoded to obtain a texture encoding result. Finally, the texture encoding result is transmitted to a head mounted display device, so that the head mounted display device decodes the texture encoding result to obtain the texture data, and displays the virtual scene picture based on the texture data. In this way, when the picture streaming method provided in some embodiments is applied to a scenario on the Windows end, streaming of a virtual scene picture on the Windows end can be implemented.

Exemplary application of a picture streaming device in embodiments of this application is first described herein. The picture streaming device is an electronic device configured to implement the picture streaming method. In an implementation, the picture streaming device (that is, an electronic device) provided in embodiments of this application may be implemented as a terminal, or may be implemented as a server. In an implementation, the picture streaming device provided in embodiments of this application may be implemented as any terminal with data processing and picture streaming functions, such as a laptop computer, a tablet computer, a desktop computer, a mobile phone, a portable music player, a personal digital assistant, a dedicated messaging device, a portable gaming device, an intelligent robot, a smart home appliance, and a smart on-board device. In another implementation, the picture streaming device provided in embodiments of this application may alternatively be implemented as a server. The server may be an independent physical server, or may be a server cluster formed by a plurality of physical servers or a distributed system, or may be a cloud server that provides basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform. The terminal and the server may be connected directly or indirectly in a wired or wireless communication manner. This is not limited in embodiments of this application. The following describes the exemplary application in which the picture streaming device is implemented as a server.

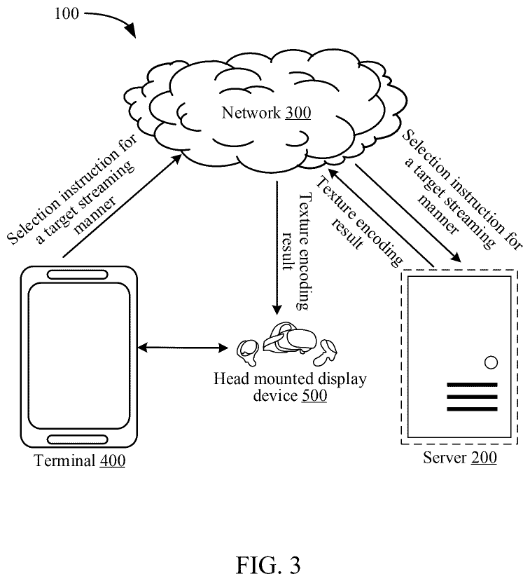

FIG. 3 is a schematic diagram showing an architecture of a picture streaming system according to an embodiment of this application. To support a picture streaming application, a virtual scene picture of a target application is streamed to a head mounted display device by using the picture streaming application. In some embodiments, at least the picture streaming application and the target application (which may be, for example, various types of VR games) are installed on a terminal. The picture streaming system 100 includes at least a head mounted display device 500, a terminal 400, a network 300, and a server 200. The server 200 is a server of the picture streaming application. The server 200 may constitute a picture streaming device in some embodiments. To be specific, a picture streaming method in embodiments of this application is implemented by using the server 200. The terminal 400 is connected to the server 200 via the network 300. The network 300 may be a wide area network or a local area network, or a combination of both.

When the virtual scene picture of the target application is streamed, a user may input a selection operation for a target streaming manner by using the picture streaming application run on the terminal 400, and the terminal 400 generates a selection instruction for the target streaming manner in response to the selection operation for the target streaming manner, and transmits the selection instruction for the target streaming manner to the server 200 via the network 300. The server 200 determines a target streaming manner at least from a first streaming manner and a second streaming manner in response to the selection instruction for the target streaming manner after receiving the selection instruction for the target streaming manner. Then, when the target streaming manner is the first streaming manner, the texture data of the virtual scene picture is obtained from the target application, and the target application is configured to render the virtual scene picture. Then, the texture data is encoded to obtain the texture encoding result. Finally, the texture encoding result is transmitted to the head mounted display device 500, so that the head mounted display device 500 decodes the texture encoding result to obtain the texture data, and displays the virtual scene picture based on the texture data.

In some embodiments, the picture streaming method in embodiments of this application may alternatively performed by the terminal 400. In other words, the user may input a selection instruction for the target streaming manner by using a picture streaming application run on the terminal 400. The terminal 400 determines a target streaming manner from at least a first streaming manner and a second streaming manner in response to the selection instruction for the target streaming manner. Then, when the target streaming manner is the first streaming manner, the texture data of the virtual scene picture is obtained from the target application, and the target application is configured to render the virtual scene picture. Then, the texture data is encoded to obtain the texture encoding result. Finally, the texture encoding result is transmitted to the head mounted display device 500, so that the head mounted display device 500 decodes the texture encoding result to obtain the texture data, and displays the virtual scene picture based on the texture data.

The picture streaming method provided in embodiments of this application may alternatively be implemented based on a cloud platform and by using a cloud technology. For example, the server 200 may be a cloud server. The cloud server determines a target streaming manner from at least a first streaming manner and a second streaming manner in response to a selection instruction for the target streaming manner. Then, when the target streaming manner is the first streaming manner, the texture data of the virtual scene picture is obtained from the target application, and the target application is configured to render the virtual scene picture. Then, the texture data is encoded to obtain a texture encoding result. Finally, the texture encoding result is transmitted to the head mounted display device 500, so that the head mounted display device 500 decodes the texture encoding result to obtain the texture data, and displays the virtual scene picture based on the texture data.

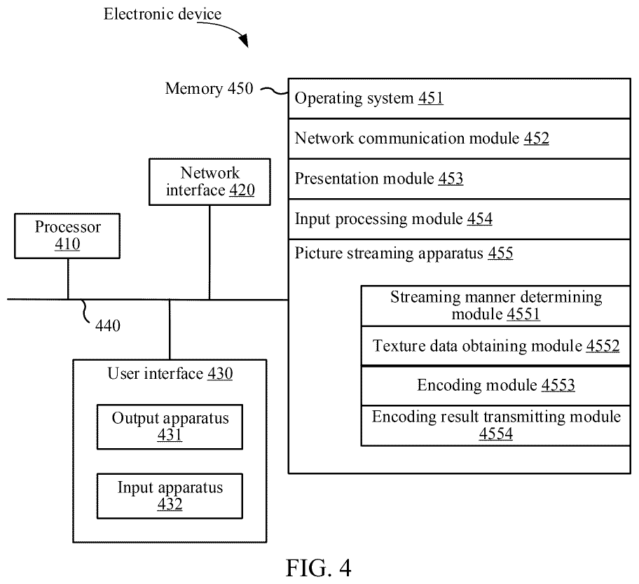

FIG. 4 is a schematic diagram showing a structure of an electronic device according to an embodiment of this application. The electronic device shown in FIG. 4 can be, e.g., the terminal 400 shown in FIG. 3, and includes at least one processor 410, a memory 450, at least one network interface 420, and a user interface 430. Components in the electronic device are coupled together by using a bus system 440. The bus system 440 is configured to implement connection and communication between these components. In addition to a data bus, the bus system 440 further includes a power bus, a control bus, and a state signal bus. However, for ease of clear description, various buses are marked as the bus system 440 in FIG. 4.

The processor 410 may be an integrated circuit chip with a signal processing capability, such as a general-purpose processor, a digital signal processor (DSP), or another programmable logic device, discrete gate, transistor logic device, or discrete hardware component. The general-purpose processor may be a microprocessor, any conventional processor, or the like.

The user interface 430 includes one or more output apparatuses 431 that present media content, including one or more speakers and/or one or more visual display screens. The user interface 430 further includes one or more input apparatuses 432 including user interface members that help user input, such as a keyboard, a mouse, a microphone, a touch display screen, a camera, other input buttons and controls.

The memory 450 may be removable, non-removable, or a combination thereof. For example, a hardware device includes a solid-state memory, a hard disk drive, an optical drive, and the like. In one embodiment, the memory 450 includes one or more storage devices physically away from the processor 410.

The memory 450 includes a volatile memory or a non-volatile memory, or may include both a volatile memory and a non-volatile memory. The non-volatile memory may be a read only memory (ROM), and the volatile memory may be a random access memory (RAM). The memory 450 described in embodiments of this application is intended to include any suitable type of memories.

In some embodiments, the memory 450 can store data to support various operations, examples of the data include a program, a module, and a data structure, or a subset or superset thereof, which are described below by using examples.

An operating system 451 includes system programs for processing various basic system services and performing hardware-related tasks, for example, a frame layer, a core library layer, and a drive layer, and is configured for implementing various basic services and processing hardware-based tasks.

A network communication module 452 is configured to reach another electronic device by using one or more (wired or wireless) network interfaces 420. Exemplary network interfaces 420 include Bluetooth, wireless compatibility certification (Wi-Fi), a universal serial bus (USB), and the like.

A presentation module 453 is configured to present information by the one or more output apparatuses 431 (such as a display screen or a speaker) associated with the user interface 430 (for example, a user interface configured to operate a peripheral device and display content and information).

An input processing module 454 is configured to detect one or more user inputs or interactions from one or more input apparatuses 432 and translate the detected inputs or interactions.

In some embodiments, the apparatus provided in embodiments of this application may be implemented in a software manner. FIG. 4 shows a picture streaming apparatus 455 stored in the memory 450, which may be software in a form of a program and a plugin, and includes the following software modules: a streaming manner determining module 4551, a texture data obtaining module 4552, an encoding module 4553, and an encoding result transmitting module 4554. The modules are logical and therefore, may be combined in different manners or further split based on to-be-implemented functions. The functions of the modules are described below.

In some other embodiments, the apparatus provided in embodiments of this application may be implemented in a hardware manner. As an example, the apparatus provided in embodiments of this application may be a processor in a form of a hardware decoding processor. The processor is programmed to perform the picture streaming method provided in embodiments of this application. For example, the processor in the form of a hardware decoding processor may use one or more application-specific integrated circuits (ASICs), a DSP, a programmable logic device (PLD), a complex programmable logic device (CPLD), a field-programmable gate array (FPGA), or another electronic component.

The picture streaming method provided in embodiments of this application may be performed by an electronic device. The electronic device may be a server or a terminal. In other words, the picture streaming method in embodiments of this application may be performed by a server or a terminal, or may be performed through an interaction between a server and a terminal.

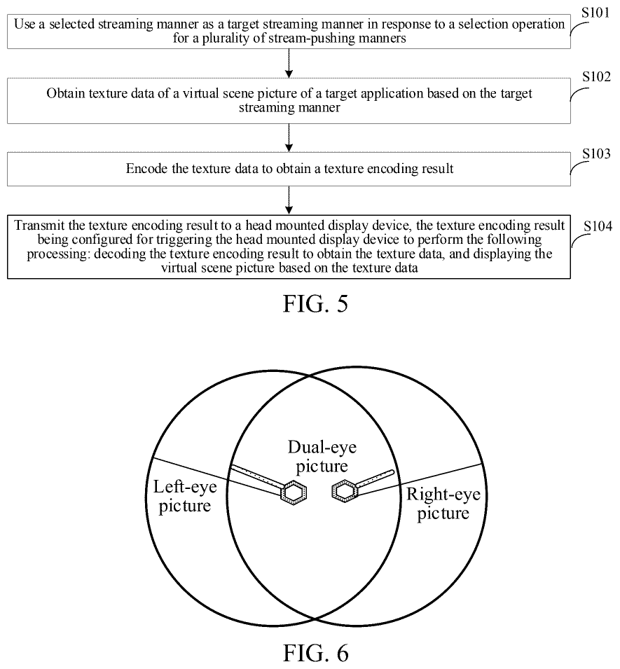

FIG. 5 is an exemplary schematic flowchart of a picture streaming method according to an embodiment of this application. The following is described in combination with operations shown in FIG. 5. As shown in FIG. 5, an example in which the picture streaming method is performed by a server is used. The method includes the following operation S101 to operation S104.

Operation S101: Use a selected streaming manner as a target streaming manner in response to a selection operation for a plurality of streaming manners.

The plurality of streaming manners herein may include a first streaming manner and a second streaming manner. For example, a user may enter a selection instruction for the target streaming manner by using a picture streaming application (DPT) on a terminal. The DPT supports at least two streaming manners: the first streaming manner and the second streaming manner. The first streaming manner may be an openxr streaming manner, and the openxr streaming manner is implemented based on a monado software development knit SDK. The second streaming manner may be a steamvr streaming manner. The user may perform selection for the two streaming manners. For example, the user may select to use the openxr streaming manner or the steamvr streaming manner as the target streaming manner to perform streaming.

Operation S102: Obtain texture data of a virtual scene picture of a target application based on the target streaming manner.

The target application herein may be configured to render the virtual scene picture. The target application may be various types of VR games.

In some embodiments, operation S102 may be implemented in the following manner: obtaining the texture data of the virtual scene picture from the target application when the target streaming manner is the first streaming manner (for example, the openxr streaming manner).

For example, the target application may be a virtual reality-related application, and supports an HMD in displaying the virtual scene picture of the target application. For example, in a scenario in which the user experiences the target application, the DPT may be deployed on a personal PC end (for example, a Windows end) of the user, the target application may be a VR game, and the virtual scene picture of the target application is a game picture of the VR game. In a development scenario of the target application, the DPT may be deployed on a cloud server end, the target application may be a game editor of the VR game, and the virtual scene picture of the target application is a game picture of the VR game. The game editor of the VR game is a tool that manufactures and develops the VR game, and for example, includes a game engine (for example, Unity) and an unreal engine (UE). A game developer may edit a particular gate scenario of the VR game in the game editor, or edit a game scene of each frame in a gate.

In embodiments of this application, there is no sequence between a starting operation of the target application and a selection operation of the target streaming manner. To be specific, the user may first start the target application, and then start the DPT to select the target streaming manner. Alternatively, the user may first start the DPT to select the target streaming manner, and then start the target application. This is not specifically limited in embodiments of this application.

In some embodiments, the target application renders the virtual scene picture during running, to obtain the texture data of the virtual scene picture. A texture is an image format, and is mainly configured for picture rendering, for example, rendering of a virtual scene picture in the VR game. The texture data of the virtual scene picture may include texture coordinates and red, green, and blue (RGB) values of each pixel on an image corresponding to the virtual scene picture. For example, when the target streaming manner is the openxr streaming manner, the texture data of the virtual scene picture of the VR game may be directly obtained from the game editor.

In some embodiments, the target application may be loaded with a first dynamic link library corresponding to the first streaming manner. That the texture data of the virtual scene picture is obtained from the target application may be implemented in the following manner: determining rendering start time of the virtual scene picture by using the first dynamic link library; obtaining pose information from the head mounted display device when a current moment reaches the rendering start time; transmitting the pose information to the target application by using the first dynamic link library, so that the target application renders the virtual scene picture based on the pose information, to obtain the texture data of the virtual scene picture. For example, a monado SDK may be run on the head mounted display device. Next, the pose information may be obtained by using the monado SDK, and the obtained pose information is transmitted to the target application, so that the target application renders the virtual scene picture based on the pose information. In this way, when rendering of the virtual scene picture ends, the texture data of the virtual scene picture can be obtained from the target application by using the first dynamic link library.

The first dynamic link library herein may be openxr_client.dll and may be VRClient invoked by a VR game in which an openxr protocol is implemented. Exemplarily, after determining that the target streaming manner is the openxr streaming manner (that is, the first streaming manner), the picture streaming application DPT may register an openxr_client.dll path interfacing with openxr in a Windows registration table. Then, the DPT may write the path under a registration path. The foregoing path may point to a json file in which a runtime library that the target application may be interfaced with by using an openxr plugin is specified. The openxr_client. dll is the runtime library. The user may write a rendering frame rate into the first dynamic link library in advance. Then, rendering start time of each frame of virtual scene picture may be determined based on the rendering frame rate by using the first dynamic link library. The frame rate can be represented by frames per second (FPS), and the rendering frame rate indicates a quantity of times of drawing a virtual scene picture in the target application per second, for example, a quantity of times of drawing an image in a game per second. The rendering frame rate may be usually set to 30 FPS, 60 FPS, 72 FPS, 90 FPS, or the like.

In some other embodiments, before streaming is performed on the virtual scene picture of the target application, a plurality of to-be-rendered textures (also referred to as “target textures”) may be created by using the first dynamic link library. For example, three to-be-rendered textures may be created by using the first dynamic link library. It is assumed that the three textures are respectively a texture 1 to a texture 3, so that the three textures may be synchronously rendered, thereby improving rendering efficiency. Before the pose information is transmitted to the target application by using the first dynamic link library, a to-be-rendered texture corresponding to the virtual scene picture may further be transmitted to the target application by using the first dynamic link library, so that the target application renders the to-be-rendered texture based on the pose information, to obtain texture data of the virtual scene picture.

A plurality of shared textures herein may be pre-created in the first dynamic link library. In this case, the shared textures may be blank canvases. The shared texture may include a plurality of texture types, such as a depth texture and a color texture. Usually, only color textures need to be used for rendering the virtual scene picture. Therefore, the color textures in the plurality of shared textures may be determined as to-be-rendered textures by using the first dynamic link library. Each frame of virtual scene picture corresponds to one to-be-rendered texture. For any frame of virtual scene picture, when a current moment reaches rendering start time of the frame of virtual scene picture, a to-be-rendered texture required by the frame of virtual scene picture may be transmitted to the target application by using the first dynamic link library. Then, pose information of the head mounted display device at a current moment may be obtained by using the first dynamic link library, and the pose information is also transmitted to the target application. The target application renders the to-be-rendered texture based on the pose information, to obtain texture data of the frame of virtual scene picture. When the rendering of the frame of virtual scene picture ends, the texture data of the frame of virtual scene picture may be obtained from the target application by using the first dynamic link library.

The DPT may obtain the pose information of the head mounted display device from the head mounted display device, and then write the pose information into the first dynamic link library. For example, the head mounted display device may be an HMD. The head mounted display device is also implemented based on the monado SDK. The monado SDK running on the head mounted display device may directly obtain head pose information, eye pose information, and information of a game controller connected to the head mounted display device, and transmit the head pose information, the eye pose information, the information of a game controller, and the like to the DPT. The eye pose information may include left-eye pose information and right-eye pose information. The texture data may include left-eye texture data and right-eye texture data. The left-eye texture data is texture data of a virtual scene picture obtained by rendering, based on the left-eye pose information, a to-be-rendered texture by the target application. After the left-eye texture data is obtained through HMD decoding, a left-eye picture provided for the left-eye of the user may be obtained. The right-eye texture data is texture data of a virtual scene picture obtained by rendering, based on the right-eye pose information, a to-be-rendered texture by the target application. After the right-eye texture data is obtained through HMD decoding, a right-eye picture provided for the right-eye of the user may be obtained. With reference to FIG. 6, the HMD may obtain left-eye texture data and right-eye texture data of the VR game by using a get_view_poses interface in the monado SDK, draw the left-eye texture data to obtain a left-eye picture, and draw the right-eye texture data to obtain a right-eye picture. The left-eye picture and the right-eye picture are cross-fused to obtain a dual-eye picture seen by the user on the HMD.

In some embodiments, the pose information of the head mounted display device is obtained by using the first dynamic link library, and the pose information corresponding to each frame of virtual scene picture and the to-be-rendered texture are transmitted to the target application, so that the target application renders the to-be-rendered texture based on the pose information, to obtain the texture data. The texture data is obtained by using the first dynamic link library, the texture data is encoded, and then the encoded texture data is transmitted to the HMD for decoding and displaying. In this way, in a rendering and streaming process based on the monado SDK, when the user uses the head mounted display device developed based on the monado SDK, the user not only can experience an application included in the head mounted display device, but also can experience a virtual scene picture of a target application on a Windows end.

In some embodiments, the determining rendering start time of the virtual scene picture by using the first dynamic link library may be implemented in the following manner: determining a rendering frame rate of the target application by using the first dynamic link library; and determining the rendering start time of the virtual scene picture based on the rendering frame rate by using the first dynamic link library.

The user herein may write a preset rendering frame rate into the first dynamic link library in advance. For example, an expected rendering frame rate written by the user into the first dynamic link library may be received by using a user interface or a configuration file. However, an actual rendering frame rate of the target application may be determined based on various factors such as performance of a graphics card by using the first dynamic link library. This is not specifically limited in embodiments of this application herein. For example, after receiving the rendering frame rate written by the user, the first dynamic link library may invoke a graphics card API (such as DirectX or OpenGL) to obtain a model, a memory size, a processing capability, and the like of a current graphics card, and then may perform a brief performance benchmark test, to estimate a maximum rendering frame rate that can be reached in a current system configuration. For example, when the rendering frame rate written by the user is higher than a rendering frame rate that can be stably provided by the graphics card, the first dynamic link library may select a slightly lower rendering frame rate as the rendering frame rate of the target application, to ensure stability and fluency. When the graphics card can reach the rendering frame rate written by the user, the rendering frame rate written by the user may be used as the rendering frame rate of the target application. After the rendering frame rate of the target application is determined, for any frame of virtual scene picture, the rendering start time of the virtual scene picture may be determined by using the first dynamic link library based on the rendering frame rate and rendering end time of a previous frame of virtual scene picture.

In some embodiments, the determining the rendering start time of the virtual scene picture based on the rendering frame rate by using the first dynamic link library may be implemented in the following manner: recording rendering end time of an i^{th} frame of virtual scene picture by using the first dynamic link library when rendering of the i^{th} frame of virtual scene picture ends, where i is an integer greater than 0; and determining, for an (i+1)^{th} frame of virtual scene picture based on the rendering frame rate and the rendering end time of the i^{th} frame of virtual scene picture by using the first dynamic link library, rendering start time of the (i+1)^{th} frame of virtual scene picture.

For example, when rendering of the 1^{st} frame of virtual scene picture ends, rendering end time of the 1^{st} frame of virtual scene picture may be recorded by using the first dynamic link library (for example, openxr_client.dll). Then, for the 2^{nd} frame of virtual scene picture, rendering start time of the 2^{nd} frame of virtual scene picture may be determined based on the rendering frame rate and the rendering end time of the 1^{st} frame of virtual scene picture by using openxr_client.dll. When rendering of the 2^{nd} frame of virtual scene picture ends, rendering end time of the 2^{nd} frame of virtual scene picture may be recorded by using openxr_client.dll. Then, for the 3^{rd} frame of virtual scene picture, rendering start time of the 3^{rd} frame of virtual scene picture may be determined based on the rendering frame rate and the rendering end time of the 2^{nd} frame of virtual scene picture by using openxr_client.dll. By analogy, rendering start time of a last frame of virtual scene picture may be determined.

In some embodiments, for the i^{th} frame of virtual scene picture, when the rendering of the i^{th} frame of virtual scene picture ends, the rendering end time of the i^{th} frame of virtual scene picture may be recorded by using the first dynamic link library. In addition, the target application notifies the first dynamic link library that the rendering of the i^{th} frame of virtual scene picture is completed, and places texture data of the i^{th} frame of virtual scene picture into a cache queue, so that the first dynamic link library obtains the texture data of the i^{th} frame of virtual scene picture from the cache queue. Then, the rendering start time of the (i+1)^{th} frame of virtual scene picture is determined based on the rendering frame rate and the rendering end time of the i^{th} frame of virtual scene picture by using the first dynamic link library.

A specific method of determining rendering start time of a current frame based on the rendering frame rate and the rendering end time of the previous frame of virtual scene picture is not specifically limited in embodiments of this application. For example, 1 s is used as a time unit, and a rendering frame rate is a quantity of rendering times in the time unit. If the rendering frame rate is 60 FPS (that is, 60 rendering times per second), after the rendering end time of the i^{th} frame of virtual scene picture is obtained, remaining time within 1 s may be calculated based on the rendering end time. For example, assuming that the i^{th} frame starts to be rendered from 0 s, a subtraction result from 1 s and the rendering end time may be used as the remaining time within 1 s. Then, a remaining quantity of times for rendering within 1 s may be calculated based on 60 FPS. For example, a result of dividing the remaining time within 1 s by time required for rendering each frame at a frame rate of 60 FPS (that is, 1/60=0.0166 s) may be used as a remaining quantity of times for rendering within 1 s. Subsequently, time required for each rendering may be evenly allocated based on the remaining time within 1 s and the quantity of times for rendering. For example, a result of dividing the remaining time within 1 s by the remaining quantity of times for rendering within 1s may be used as evenly allocated time required for each rendering. Further, rendering start time of the (i+1)^{th} frame may be determined based on the rendering end time of the i^{th} frame and time required for each rendering. For example, a result of adding the rendering end time of the i^{th} frame and evenly allocated time required for each rendering may be used as the rendering start time of the (i+1)^{th} frame, thereby implementing smooth rendering.

In other words, when a current moment reaches the rendering start time of the (i+1)^{th} frame of virtual scene picture, a to-be-rendered texture of the (i+1)^{th} frame of virtual scene picture may be transmitted to the target application by using the first dynamic link library, to start rendering of the (i+1)^{th} frame of virtual scene picture.

In some embodiments, rendering start time of a current frame of virtual scene picture is determined based on the rendering frame rate and the rendering end time of the previous frame of virtual scene picture by using the first dynamic link library, to implement smooth rendering of each frame of virtual scene picture, improve a picture rendering effect, further improve a display effect after the virtual scene picture is streamed to the HMD, and improve playing fluency of the virtual scene picture.

In some embodiments, the pose information of the head mounted display device may include head pose information and eye pose information. That the pose information is transmitted to the target application by using the first dynamic link library may be implemented in the following manner: transmitting the eye pose information to the target application by using the first dynamic link library; and initializing the head pose information to a set value (for example, 0) by using the first dynamic link library, and transmitting the head pose information initialized to 0 to the target application.

In some embodiments, the pose information of the head mounted display device may include head pose information and eye pose information, where the head pose information may include a position and orientation information of the head of the user; and the eye pose information may include positions, orientation information, and field of view information of two eyes of the user. When a current moment reaches rendering start time of the i^{th} frame of virtual scene picture, a to-be-rendered texture of the i^{th} frame of virtual scene picture is transmitted to the target application by using the first dynamic link library, and then the eye pose information returned by the HMD is transmitted to the target application by using the first dynamic link library. Values of a position and an orientation in the head pose information returned by the HMD are both filled with 0 by using the first dynamic link library, and then the head pose information initialized to 0 is transmitted to the target application by using the first dynamic link library. Because a value of the head pose information received by the target application is 0, the target application does not render the to-be-rendered texture by using the head pose information. To be specific, the target application renders the to-be-rendered texture of the i^{th} frame of virtual scene picture based on only the eye pose information, to obtain texture data of the i^{th} frame of virtual scene picture.

In the related technology, when the monado SDK requires, based on the openxr protocol, the HMD to obtain pose information, head pose information and eye pose information need to be introduced at the same time. However, this method is only applicable to the VR game running in the HMD, and is not applicable to a streaming scenario. Therefore, in some embodiments, the head pose information is initialized to 0 during streaming, so that the VR game on the Windows end does not refer to head pose prediction during rendering, and only refers to an existing dual-eye pose. The head pose information is filled with 0, so that the VR game does not use the head pose information for prediction and rendering, to ensure that during streaming, the user does not have a vertigo feeling when viewing a picture, and the immersion can be consistent with that of steamvr.

In some other embodiments, operation S102 may further be implemented in the following manner: obtaining, when the target streaming manner is the second streaming manner, the texture data of the virtual scene picture of the target application through a streaming process corresponding to the second streaming manner.

The second streaming manner herein may be a steamvr streaming manner. A streaming process corresponding to the second streaming manner is a steamvr streaming application. After determining that the target streaming manner is the second streaming manner, the DPT may start a steamvr streaming application, and obtain texture data of each frame of virtual scene picture of the target application by using the steamvr streaming application. Then, the DPT encodes the texture data of each frame of virtual scene picture, to obtain a texture encoding result corresponding to each frame of virtual scene picture. Meanwhile, the DPT may further encode audio used in each frame of virtual scene picture, to obtain an audio encoding result. The texture encoding result and the audio encoding result are transmitted to the head mounted display device together, so that the head mounted display device decodes the texture encoding result and the audio encoding result to obtain the texture data and the audio, and plays the audio obtained through decoding while displaying the virtual scene picture to the user based on the texture data.

In some embodiments, the steamvr streaming application is introduced, so that the steamvr streaming manner is supported while the openxr streaming manner is implemented, so as to be compatible with an HMD device or a VR game developed without using the openxr protocol, thereby improving universality of the streaming method.

In some embodiments, the obtaining the texture data of the virtual scene picture of the target application through a streaming process corresponding to the second streaming manner may be implemented based on the following manner: registering a second dynamic link library corresponding to the second streaming manner to the streaming process corresponding to the second streaming manner; obtaining head pose information from the head mounted display device; writing the head pose information into the streaming process by using the second dynamic link library, the streaming process being configured for performing rendering based on the head pose information to obtain the texture data of the virtual scene picture; and obtaining the texture data from the streaming process by using the second dynamic link library.

The second dynamic link library corresponding to the second streaming manner herein may be openvr_client. dll, for example, may be a VRClient invoked by steamvr. Exemplarily, after it is determined that the target streaming manner is the steamvr manner, openvr_client.dll may be registered to the steamvr streaming application. The steamvr streaming application may directly interface with the target application. After obtaining the head pose information from the HMD, the DPT transmits the head pose information to the steamvr streaming application by using openvr_client. dll. The steamvr streaming application may calculate the eye pose information based on the head pose information. For example, when the head mounted display device supports eye detection, eye pose information (for example, including positions and orientations of a left eye and a right eye of the user) of the user may be estimated with reference to the head pose information and eye detection data of the user. When the head mounted display device does not support eye detection, a fixed eye position offset (which usually offsets outward from a center position of the head of the user) may be used to approximately calculate the eye pose information, and texture data of the virtual scene picture of the target application is obtained through rendering based on the head pose information and the eye pose information. Finally, the texture data is obtained from the streaming process by using the second dynamic link library.

Operation S103: Encode the texture data to obtain a texture encoding result.

The DPT herein may encode the texture data after obtaining the texture data of each frame of virtual scene picture transmitted by the first dynamically link library, to obtain a texture encoding result corresponding to each frame of virtual scene picture. An encoding manner of the texture data is not specifically limited in embodiments of this application. For example, the texture data may be encoded by using a software encoding manner or by using a hardware encoding manner. In addition, audio used in each frame of virtual scene picture may further be encoded, to obtain an audio encoding result.

Operation S104: Transmit the texture encoding result to the head mounted display device, the texture encoding result being configured for triggering the head mounted display device to perform the following processing: decoding the texture encoding result to obtain the texture data, and displaying the virtual scene picture based on the texture data.

The DPT herein may jointly transmit the texture encoding result and the audio encoding result to the HMD. After receiving the texture encoding result and the audio encoding result, the HMD decodes the texture encoding result and the audio encoding result to obtain the texture data and the audio of the virtual scene picture, and plays the audio obtained through decoding while displaying the virtual scene picture to the user based on the texture data.

In some embodiments, when the virtual scene picture of the target application is streamed to the head mounted display device, the target streaming manner is determined from at least the first streaming manner and the second streaming manner. When the first streaming manner is used, the texture data of the virtual scene picture is first obtained from the target application, then the texture data is encoded to obtain a texture encoding result, and then the texture encoding result is transmitted to the head mounted display device. The head mounted display device may decode the texture encoding result to obtain the texture data, and display the virtual scene picture based on the texture data. Because the first streaming manner is implemented based on the monado software development knit SDK, when embodiments of this application is applied to a scenario of the Windows end, streaming of a virtual scene picture on the Windows end may be implemented based on the monado SDK, so that the head mounted display device developed based on the monado SDK can also adapt to a target application on the Windows end. In this way, when the user uses the head mounted display device developed based on the monado SDK, the user can not only experience an application included in the head mounted display device, but also experience the virtual scene picture of the target application on the Windows end. In addition, according to the picture streaming method provided in embodiments of this application, in the first streaming manner, when rendering the to-be-rendered texture to obtain the texture data of the virtual scene picture, the target application initializes the head pose information of the HMD to 0, and only uses the eye pose information to render the to-be-rendered texture, to ensure that in a streaming process, when the user rotates the head, a surrounding scene does not rotate, thereby preventing vertigo. The picture streaming method provided in embodiments of this application may further support the second streaming manner, so as to be compatible with an HMD device or a VR game developed without using the openxr protocol, thereby improving universality of the picture streaming method.

Exemplary application of embodiments of this application in an actual application scenario is described below.

An embodiment of this application provides a picture streaming method. The method may be applied to a picture streaming application DPT (XR_DirectPreview_Tool) provided in embodiments of this application. The DPT is installed on the Windows end, and supports both openxr streaming (the first streaming manner) and steamvr streaming (the second streaming manner). The first streaming manner in the picture streaming method provided in some embodiments is implemented based on the monado software development knit SDK. Therefore, in some embodiments, streaming of the virtual scene picture on the Windows end may be implemented based on the monado SDK.

The solution in embodiments of this application may be applied to a development scenario of a VR game, or may be applied to a scenario in which a user experiences the VR game. The following describes the picture streaming method and the picture streaming application DPT provided in embodiments of this application by using a development scenario of the VR game as an example.

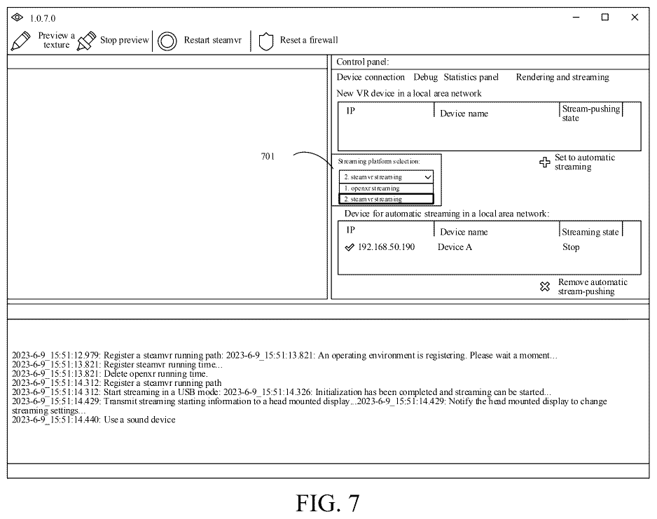

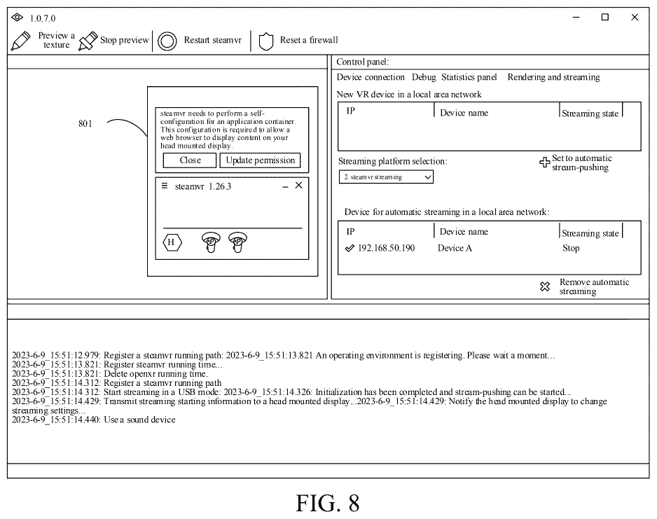

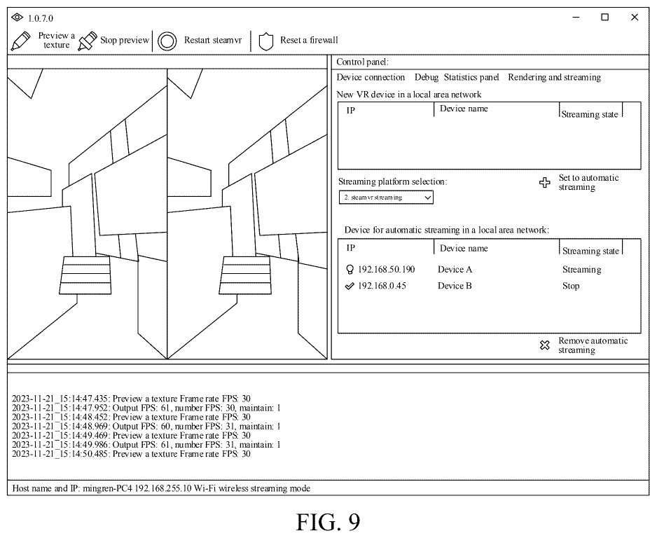

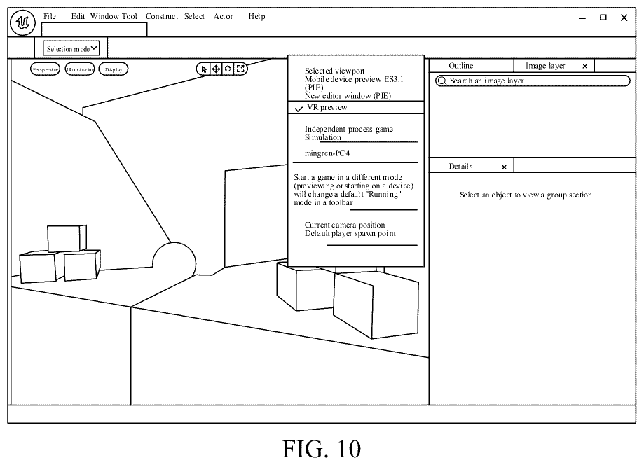

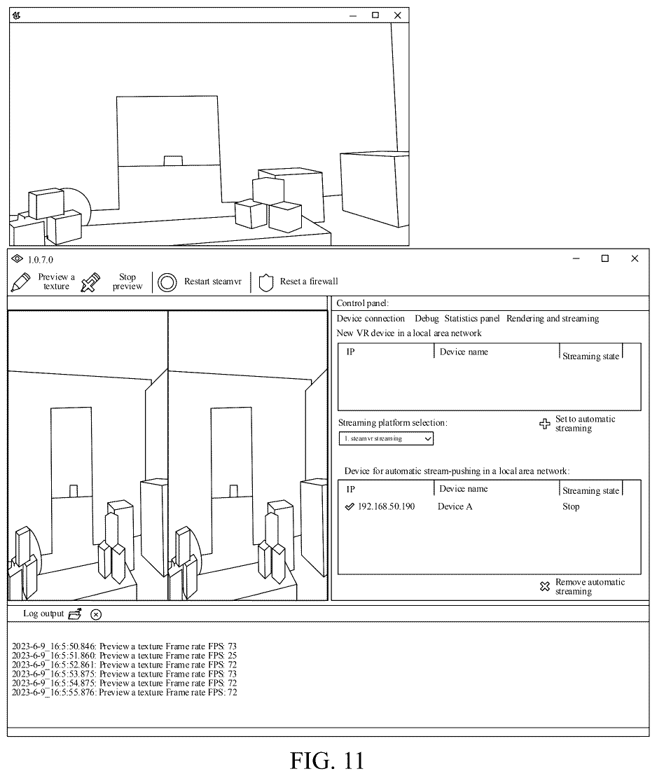

In the development scenario of the VR game, the DPT may be deployed in a cloud server, to be used by a plurality of users together. The users may be game developers. FIG. 7 is a schematic diagram showing a client interface of DPT according to an embodiment of this application. With reference to FIG. 7, a user may perform an interactive operation by using a selection box 701 on an interface of a DPT client. The interactive operation may be a click operation on “1. openxr streaming” or “2. steamvr streaming” under “Streaming platform selection” in the selection box 701. With reference to FIG. 8, when the user selects steamvr to perform streaming, the DPT pulls a steamvr process 801 (a streaming process corresponding to a second streaming manner), and registers a VRClient (openvr_client.dll, a second dynamic link library) of a streaming tool to a steamvr environment. With reference to FIG. 9, openvr_client.dll may obtain textures of a left eye and a right eye (that is, texture data of the virtual scene picture) of the VR game (that is, a target application) from steamvr, transmit the textures of a left eye and a right eye to the DPT for video encoding, and finally transmit encoded data (that is, a texture encoding result) to a head mounted display HMD for decoding and displaying a picture. The DPT may further perform a texture preview operation on the textures of a left eye and a right eye. With reference to FIG. 10, when the user selects openxr to perform streaming, the cloud server may open a game editor (for example, a UE) of the VR game. With reference to FIG. 11, a picture of a current gate may be directly streamed to a head mounted display HMD in the game editor. The user can directly experience current gate content without deploying a PC host again and waiting for the UE to package.

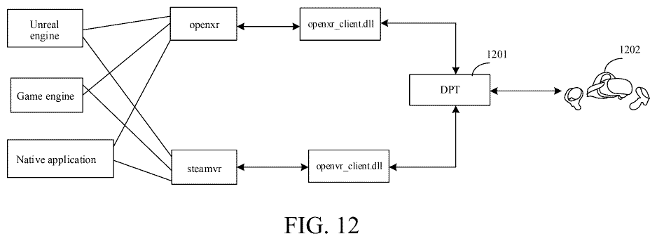

In some embodiments, the DPT may be compatible with two functional modules: openxr and steamvr, where openvr_client. dll is responsible for implementing rendering and image grabbing of steamvr; and openxr_client. dll may abandon a platform of steamvr to interface with the game editor, and directly implement rendering and image grabbing from a game. steamvr depends on a steam platform, and there is a large amount of game content. Therefore, a streaming tool of a VR hardware manufacturer may preferentially access steamvr as a streaming platform of the steamvr. Compared with openvr_client.dll of steamvr, openxr_client.dll is more complex to implement, directly interfaces with a game editor (or a game), and is responsible for completing game rendering, time prediction of rendering of next frame of picture, event writing of an input device, and the like. An openxr rendering and streaming tool with good maturity still does not exist in the related technology. FIG. 12 is a schematic diagram showing streaming processes of openxr and steamvr according to an embodiment of this application. DPT 1201 is responsible for connecting a VR device (HMD) 1202 by using a universal serial bus (USB) or a wireless network (Wi-Fi), to obtain pose information, information of a game controller, and the like of the HMD 1202. In an openxr streaming process, the DPT 1201 transmits the pose information and the information of a game controller to openxr_client. dll, and openxr_client. dll implements an openxr protocol, and interfaces with rendering logic of a game editor (a UE, a Unity, or a native application Native APP). Openxr_client.dll transmits the pose information and the information of a game controller to the game editor, so that the game editor completes rendering of textures of a left eye and a right eye based on the pose information and the information of a game controller. Openxr_client.dll obtains the textures of a left eye and a right eye from the game editor, and transmits the textures of a left eye and a right eye to the DPT 1201. After performing video encoding on the textures of a left eye and a right eye, the DPT 1201 transmits the video encoding and the audio encoding together to the HMD 1202. In a steamvr streaming process, the DPT 1201 transmits the pose information and the information of a game controller to openvr_client.dll. openvr_client.dll implements an openvr protocol, and interfaces with steamvr. Openvr_client.dll transmits the pose information and the information of a game controller to steamvr, so that steamvr completes rendering of the textures of a left eye and a right eye based on the pose information and the information of a game controller. Openvr_client.dll obtains the textures of a left eye and a right eye from steamvr, and transmits the textures of a left eye and a right eye to the DPT 1201. After performing video encoding on the textures of a left eye and a right eye, the DPT 1201 transmits the video encoding and the audio encoding together to the HMD 1202.

An openxr streaming manner provided in embodiments of this application is described in detail below.

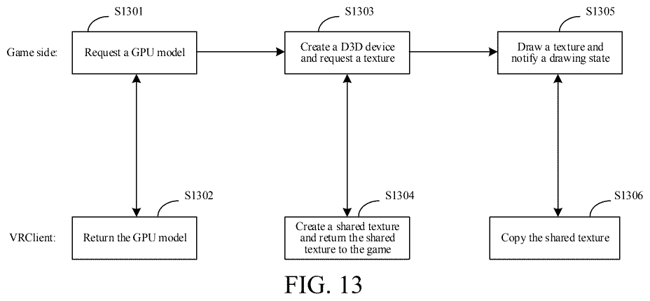

FIG. 13 is a schematic flowchart of an interaction between a game side and VRClient according to an embodiment of this application. Descriptions are provided with reference to operations shown in FIG. 13. Operation S1301: Request a GPU model. First, a game may apply to VRClient for the GPU model of a terminal on which the game is located by using an xrGetD3D11GraphicsRequirementsKHR interface of openxr. Operation S1302: Return the GPU model. The VRClient may return the GPU model to the game. Operation S1303: Create a D3D device and request a texture. A game side may create the D3D device based on the GPU model returned by the VRClient, and request a texture to the VRClient by using an xrCreateSwapchain interface. Operation S1304: Create a shared texture and return the shared texture to the game. VRClient creates the shared texture, and returns the shared texture configured for drawing the textures of a left eye and a right eye to the game. Operation S1305: Draw a texture and notify a drawing state. The game may draw the shared texture returned by the VRClient, to obtain the textures of a left eye and a right eye. After completing rendering of each frame of image of textures of a left eye and a right eye, the game notifies, by using an xrEndFrame interface, VRClient that a drawing state is completed. Operation S1306: Copy the shared texture. In this case, VRClient may copy a texture from the texture of the game and transfer the texture to an external process for use, that is, transfer the texture to the DPT for encoding.

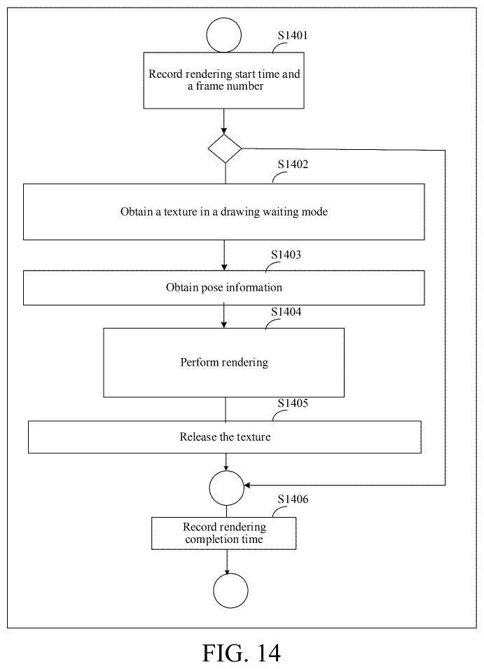

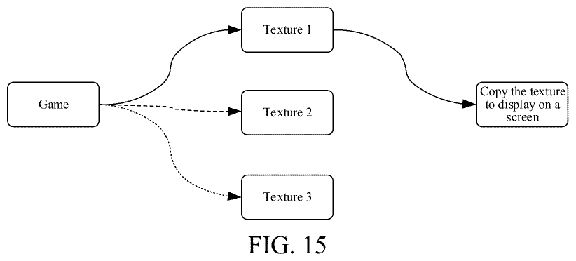

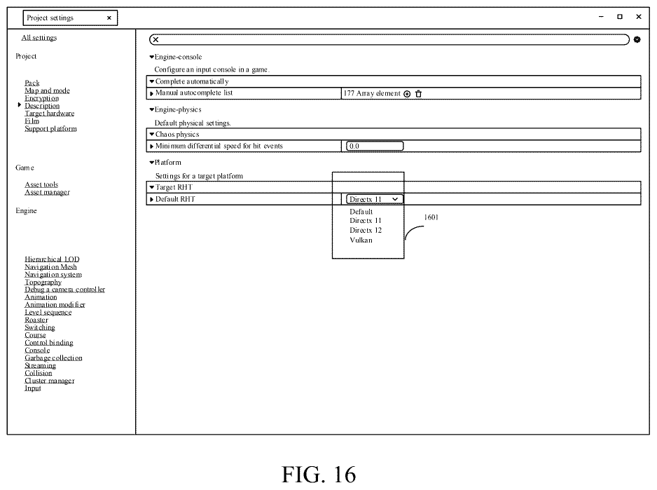

FIG. 14 is a schematic diagram showing a rendering process of a game according to an embodiment of this application. The following describes operations shown with reference to FIG. 14. Operation S1401: Record rendering start time and a frame number. First, the game may invoke an xrWaitFrame interface and an xrBenginFrame interface, so that a dynamic link library (VRClient) records rendering time and a frame number of each frame of image. Operation S1402: Obtain a texture in a drawing waiting mode. The game may obtain a number of a renderable texture from VRClient by using an xrAcquireSwapchainImage interface. With reference FIG. 15, VRClient may create a plurality of textures (for example, including three textures, which are respectively a texture 1, a texture 2, and a texture 3), for rendering by the game in sequence, thereby implementing asynchronous copying of the textures. Then, the game obtains, by using an xrWaitSwapchainImage interface, the texture in the drawing waiting mode. The xrWaitSwapchainImage interface is configured for waiting for a selected texture to be in the drawing waiting mode. For a specific implementation method, reference may be made to different implementation modes in OpenGL and Vulkan that enable a texture to be in the drawing waiting mode. Operation S1403: Obtain pose information. The game invokes xrLocateViews and xrLocateSpace interfaces to obtain the pose information of an HMD, where the pose information is mainly configured for simulating up-down, left-right, and front-back position changes of the head. Operation S1404: Perform rendering. The game renders (Execute Graphics Work) the texture in the waiting drawing mode based on the obtained pose information. Operation S1405: Release the texture. After rendering is completed, the game invokes an xrReleaseSawapchain interface, so that VRClient releases the texture. Operation S1406: Record rendering completion time. The game invokes the xrEndFrame interface to indicate that drawing of a current frame of image is completed, notifies VRClient that rendering of the texture is completed, and records rendering completion time. In addition, a user may control a rendering frame rate by using three xr interfaces: the xrWaitFrame interface, the xrBenginFrame interface, and the xrEndFrame interface. For example, a game developer may configure a rendering frame rate of 60 FPS or 90 FPS in VRClient, and the three interfaces may control a rendering period of the game based on a specified rendering frame rate. After invoking the xrEndFrame interface, the game may put a rendered texture into a cache queue, and then the DPT obtains the rendered texture from the cache queue, performs video encoding on the rendered texture, and then transmits the rendered texture to the head mounted display for decoding and playing. With reference to 16, the DPT provided in embodiments of this application can implement rendering of two graphics devices, d3d11 and d3d12. The user can switch between different graphics devices according to actual needs in a graphics device selection box 1601 in FIG. 16.

The steamvr streaming manner provided in embodiments of this application is described in detail below.

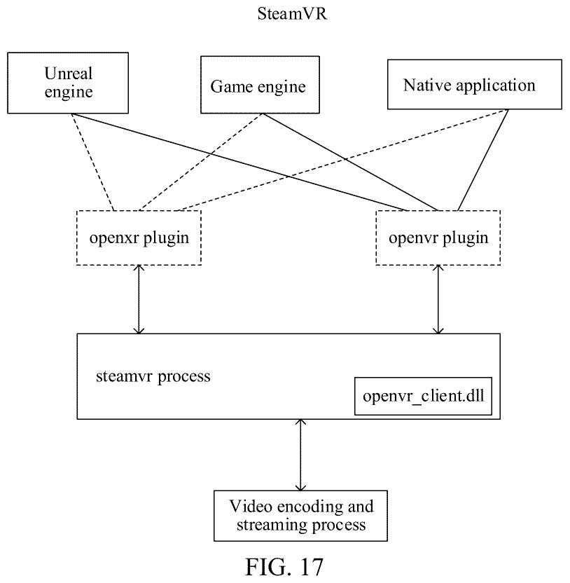

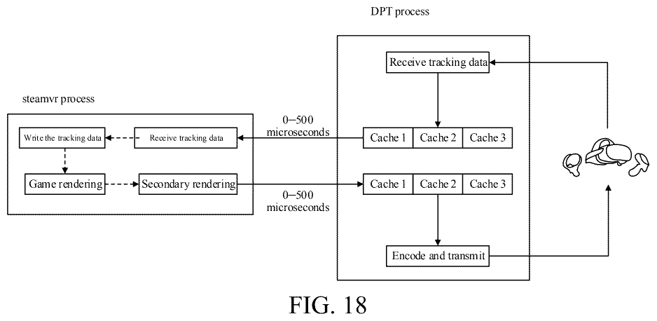

FIG. 17 is a schematic diagram showing a rendering process within steamvr according to an embodiment of this application. As shown in FIG. 17, rendering of steamvr is different from that of openxr. steamvr implements two rendering modes of openvr and openxr inside, but is finally provided to external invocation in a manner of openvr, so as to be compatible with old games and streaming tools. That is, steamvr includes an openxr plugin and an openvr plugin, and performs streaming only by using an openvr_client.dll dynamic link library. FIG. 18 is a schematic diagram showing steamvr streaming according to an embodiment of this application. As shown in FIG. 18, openvr_client.dll is loaded by steamvr into a process of steamvr, then the DPT transmits Tracking data obtained from the head mounted display to openvr_client.dll, and openvr_client.dll writes the Tracking data into an interface of steamvr. After completing rendering a frame of image, the game notifies steamvr. Next, steamvr transmits textures of a left eye and a right eye of the game to openvr_client. dll. Finally, openvr_client. dll transmits the textures of a left eye and a right eye of the game to the DPT for video encoding and transmitting.

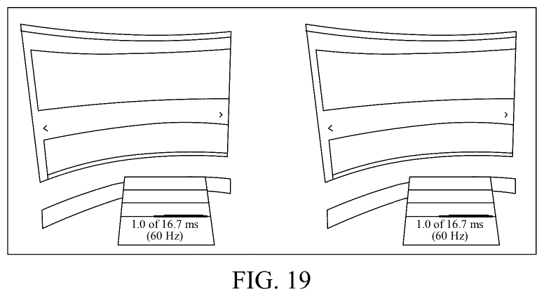

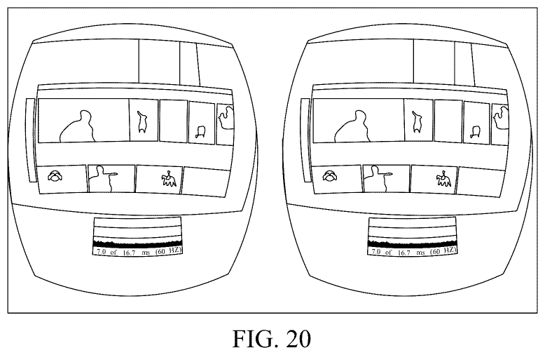

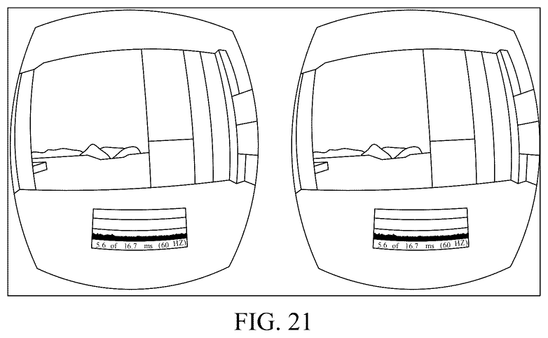

The picture streaming method provided in some embodiments is implemented based on the monado SDK. Correspondingly, an external HMD end also runs the monado SDK, so as to implement rendering and running of the VR game installed on the HMD end. A rendering manner on the HMD end is specifically described below. An openxr runtime (an implementation of the monado SDK) is also run in a head mounted display HMD, and each hardware manufacturer implements an openxr runtime according to a hardware environment and parameters of the manufacturer. The openxr runtime first calculates pose information and predicted pose information by using the hardware environment (refreshing and a rendering frame rate of a screen) of the openxr runtime. Then, the information is externally exposed to the user for invocation by using an openxr interface (xrLocateViews and xrLocateSpace). In some embodiments, during streaming, positions and orientations of the head and two eyes may be obtained by using two interfaces: xrLocateViews and xrLocateSpace. After the pose information is transmitted to the DPT on the Windows side, the game draws textures of a left eye and a right eye based on the pose information. For the drawn textures of a left eye and a right eye, reference may be made to FIG. 19. After the DPT encodes the textures of a left eye and a right eye and transmits the textures to the head mounted display, textures decoded by the head mounted display are also textures of a left eye and a right eye. However, after the head mounted display performs secondary rendering of optical distortion of head mounted display hardware for displaying on a screen, the textures become two pictures with an elliptic effect and a curved effect, as shown in FIG. 20. With reference to FIG. 21, the textures of a left eye and a right eye are distorted when seen on a plane, and become natural after being projected to human eyes through a VR lens.

The picture streaming method provided in some embodiments can achieve a streaming effect consistent with basic experience of steamvr. When the monado SDK has not streamed an HMD for streaming in an open source, the picture streaming method provided in some embodiments may be used to achieve effects of pose movement and streaming. In the picture streaming method provided in some embodiments, predicted time information of the head mounted display may further be transmitted to a Windows end, so that reference is made to the predicted time information and pose information of the head mounted display during game rendering.

Related data such as user information is involved in embodiments of this application. When embodiments of this application are applied to a specific product or technology, user permission or consent is required, and collection, use, and processing of related data need to comply with related laws, regulations, and standards in related countries and regions.

An exemplary structure of a picture streaming apparatus 455 provided in embodiments of this application implemented as a software module is further described below. In some embodiments, as shown in FIG. 4, software modules in the picture streaming apparatus 455 stored in the memory 450 may include:
a streaming manner determining module 4551, configured to use a selected streaming manner as a target streaming manner in response to a selection operation for a plurality of streaming manners;
a texture data obtaining module 4552, configured to obtain texture data of a virtual scene picture of a target application based on a target streaming manner, the target application being configured for rendering the virtual scene picture;
an encoding module 4553, configured to encode the texture data to obtain a texture encoding result; and
an encoding result transmitting module 4554, configured to transmit the texture encoding result to a head mounted display device, the texture encoding result being configured for triggering the head mounted display device to perform the following processing: decoding the texture encoding result to obtain the texture data, and displaying the virtual scene picture based on the texture data.

In some embodiments, the plurality of streaming manners includes a first streaming manner and a second streaming manner, and the texture data obtaining module 4552 is further configured to obtain the texture data of the virtual scene picture from the target application when the target streaming manner is the first streaming manner.

In some embodiments, the target application is loaded with a first dynamic link library corresponding to the first streaming manner. The texture data obtaining module 4552 is further configured to determine rendering start time of the virtual scene picture by using the first dynamic link library; obtain pose information from the head mounted display device when a current moment reaches the rendering start time; transmit the pose information to the target application by using the first dynamic link library, to enable the target application to render the virtual scene picture based on the pose information, to obtain the texture data of the virtual scene picture; and obtain, when rendering of the virtual scene picture ends, the texture data of the virtual scene picture from the target application by using the first dynamic link library.

In some embodiments, the pose information of the head mounted display device includes head pose information and eye pose information. The texture data obtaining module 4552 is further configured to transmit the eye pose information to the target application by using the first dynamic link library; and initialize the head pose information to a set value by using the first dynamic link library, and transmit the head pose information initialized to the set value to the target application.

In some embodiments, the picture streaming apparatus 455 further includes a texture creating module, configured to create a plurality of to-be-rendered textures by using the first dynamic link library. The texture data obtaining module 4552 is further configured to transmit a to-be-rendered texture corresponding to the virtual scene picture to the target application by using the first dynamic link library, to enable the target application to render the to-be-rendered texture based on the pose information, to obtain the texture data of the virtual scene picture.

In some embodiments, the texture data obtaining module 4552 is further configured to determine a rendering frame rate of the target application by using the first dynamic link library; and determine the rendering start time of the virtual scene picture based on the rendering frame rate by using the first dynamic link library.

In some embodiments, the texture data obtaining module 4552 is further configured to record, when rendering of an i^{th} frame of virtual scene picture ends, rendering end time of the i^{th} frame of virtual scene picture by using the first dynamic link library, i being an integer greater than 0; determine, for an (i+1)^{th} frame of virtual scene picture, rendering start time of the (i+1)^{th} frame of virtual scene picture based on the rendering frame rate and the rendering end time of the i^{th} frame of virtual scene picture by using the first dynamic link library.

In some embodiments, the plurality of streaming manners includes a first streaming manner and a second streaming manner, and the picture streaming apparatus further includes a second streaming module, configured to obtain, when the target streaming manner is the second streaming manner, the texture data of the virtual scene picture of the target application through a streaming process corresponding to the second streaming manner.

In some embodiments, the second streaming module is further configured to register a second dynamic link library corresponding to the second streaming manner to the streaming process corresponding to the second streaming manner; obtain head pose information from the head mounted display device; write the head pose information into the streaming process by using the second dynamic link library, the streaming process being configured for performing rendering based on the head pose information to obtain the texture data of the virtual scene picture; and obtain the texture data from the streaming process by using the second dynamic link library.

An embodiment of this application provides a computer program product. The computer program product includes a computer program or computer-executable instructions. The computer program or the computer-executable instructions are stored in a computer-readable storage medium. A processor of an electronic device reads the computer-executable instructions or the computer program from the computer-readable storage medium. The processor executes the computer-executable instructions or the computer program, to cause the electronic device to perform the foregoing picture streaming method in embodiments of this application.

An embodiment of this application provides a computer-readable storage medium having computer-executable instructions or computer program stored therein. When the computer-executable instructions or computer program is executed by a processor, the processor is caused to perform the picture streaming method according to embodiments of this application, such as the picture streaming method shown in FIG. 5.

In some embodiments, the computer-readable storage medium may be a memory such as a RAM, a ROM, a flash memory, a magnetic surface memory, an optical disc, or a CD-ROM, or may be various devices including one or any combination of the memories.

In some embodiments, the computer-executable instructions may be written in any form of programming language (including a compiled or interpreted language, or a declarative or procedural language) in a form of a program, software, a software module, a script, or code, and may be deployed in any form, including being deployed as an independent program or being deployed as a module, a component, a subroutine, or another unit applicable for use in a computing environment.

In an example, the computer-executable instructions may but do not necessarily correspond to a file in a file system, and may be stored as a part of a file that saves other programs or data, for example, stored in one or more scripts in a Hypertext Markup Language (HTML) document, stored in a single file dedicated to a discussed program, or stored in a plurality of collaborative files (for example, files that store one or more modules, subprograms, or code parts).

As an example, the computer-executable instructions may be deployed to be executed on one electronic device or on a plurality of electronic devices located in one location, alternatively, on a plurality of electronic devices distributed in a plurality of locations and interconnected through communication networks.

In conclusion, according to embodiments of this application, streaming of the virtual scene picture on the Windows end may be implemented based on the monado SDK.

The foregoing descriptions described above are merely examples of embodiments of this application, and this is not intended to limit the scope of this application. Any modification, equivalent replacement, and improvement within the spirit and scope of this application are included in the scope of this application.

What is claimed is:

1. A picture streaming method, performed by an electronic device, comprising:
obtaining texture data of a virtual scene picture of a target application based on a target streaming manner selected from a plurality of streaming manners, the target application being configured to render the virtual scene picture;
encoding the texture data to obtain a texture encoding result; and
transmitting the texture encoding result to a head mounted display device, the texture encoding result being configured for triggering the head mounted display device to decode the texture encoding result to obtain the texture data, and display the virtual scene picture based on the texture data.

2. The method according to claim 1, wherein:
the plurality of streaming manners include a first streaming manner and a second streaming manner; and
obtaining the texture data includes:
obtaining the texture data of the virtual scene picture from the target application in response to the target streaming manner being the first streaming manner.

3. The method according to claim 2, wherein:
the target application is loaded with a dynamic link library corresponding to the first streaming manner; and
obtaining the texture data from the target application includes:
determining rendering start time of the virtual scene picture using the dynamic link library;
obtaining pose information from the head mounted display device in response to a current moment reaching the rendering start time;
transmitting the pose information to the target application using the dynamic link library, the pose information being configured for triggering the target application to render the virtual scene picture based on the pose information, to obtain the texture data; and
obtaining, in response to ending of rendering of the virtual scene picture, the texture data from the target application using the dynamic link library.

4. The method according to claim 3, wherein:
the pose information includes head pose information and eye pose information; and transmitting the pose information to the target application includes:
transmitting the eye pose information to the target application using the dynamic link library; and
initializing the head pose information to a set value using the dynamic link library, and transmitting the head pose information initialized to the set value to the target application.

5. The method according to claim 3, further comprising:
creating a plurality of target textures using the dynamic link library; and
before transmitting the pose information to the target application:
transmitting one target texture of the target textures that corresponds to the virtual scene picture to the target application using the dynamic link library, the one target texture being configured for triggering the target application to render the one target texture based on the pose information, to obtain the texture data.

6. The method according to claim 3, wherein determining the rendering start time includes:
determining a rendering frame rate of the target application using the dynamic link library; and
determining the rendering start time based on the rendering frame rate using the dynamic link library.

7. The method according to claim 6, wherein determining the rendering start time based on the rendering frame rate includes:
recording, in response to ending of rendering of an i^{th} frame of virtual scene picture, rendering end time of the i^{th} frame of virtual scene picture using the dynamic link library, i being an integer greater than 0; and
determining rendering start time of an (i+1)^{th} frame of virtual scene picture based on the rendering frame rate and the rendering end time of the i^{th} frame of virtual scene picture using the dynamic link library.

8. The method according to claim 1, wherein:
the plurality of streaming manners include a first streaming manner and a second streaming manner; and
obtaining the texture data includes:
obtaining, in response to the target streaming manner being the second streaming manner, the texture data of the virtual scene picture of the target application through a streaming process corresponding to the second streaming manner.

9. The method according to claim 8, wherein obtaining the texture data through the streaming process corresponding to the second streaming manner includes:
registering a dynamic link library corresponding to the second streaming manner to the streaming process corresponding to the second streaming manner;
obtaining head pose information from the head mounted display device;
writing the head pose information into the streaming process using the dynamic link library, the streaming process being configured for performing rendering based on the head pose information to obtain the texture data; and
obtaining the texture data from the streaming process using the dynamic link library.

10. The method according to claim 9, further comprising:
determining eye pose information based on the head pose information;
wherein writing the head pose information into the streaming process includes:
writing the head pose information and the eye pose information into the streaming process using the dynamic link library, the streaming process being configured for performing rendering based on the head pose information and the eye pose information to obtain the texture data.

11. The method according to claim 1, further comprising:
encoding audio used in the virtual scene picture, to obtain an audio encoding result;
wherein transmitting the texture encoding result to the head mounted display device includes:
transmitting the texture encoding result and the audio encoding result to the head mounted display device, the texture encoding result and the audio encoding result being configured for triggering the head mounted display device to decode the texture encoding result and the audio encoding result to obtain the texture data and the audio, and play the audio when the virtual scene picture is displayed based on the texture data.

12. An electronic device comprising:
a memory storing computer-executable instructions or a computer program; and
a processor configured to execute the computer-executable instructions or the computer program to:
obtain texture data of a virtual scene picture of a target application based on a target streaming manner selected from a plurality of streaming manners, the target application being configured to render the virtual scene picture;
encode the texture data to obtain a texture encoding result; and
transmit the texture encoding result to a head mounted display device, the texture encoding result being configured for triggering the head mounted display device to decode the texture encoding result to obtain the texture data, and display the virtual scene picture based on the texture data.

13. The electronic device according to claim 12, wherein:
the plurality of streaming manners include a first streaming manner and a second streaming manner; and
the processor is further configured to execute the computer-executable instructions or the computer program to, when obtaining the texture data:
obtain the texture data of the virtual scene picture from the target application in response to the target streaming manner being the first streaming manner.

14. The electronic device according to claim 13, wherein:
the target application is loaded with a dynamic link library corresponding to the first streaming manner; and
the processor is further configured to execute the computer-executable instructions or the computer program to, when obtaining the texture data from the target application:
determine rendering start time of the virtual scene picture using the dynamic link library;
obtain pose information from the head mounted display device in response to a current moment reaching the rendering start time;
transmit the pose information to the target application using the dynamic link library, the pose information being configured for triggering the target application to render the virtual scene picture based on the pose information, to obtain the texture data; and
obtain, in response to ending of rendering of the virtual scene picture, the texture data from the target application using the dynamic link library.

15. The electronic device according to claim 14, wherein:
the pose information includes head pose information and eye pose information; and
the processor is further configured to execute the computer-executable instructions or the computer program to, when transmitting the pose information to the target application:
transmit the eye pose information to the target application using the dynamic link library; and
initialize the head pose information to a set value using the dynamic link library, and transmitting the head pose information initialized to the set value to the target application.

16. The electronic device according to claim 14, wherein the processor is further configured to execute the computer-executable instructions or the computer program to:
create a plurality of target textures using the dynamic link library; and
before transmitting the pose information to the target application:
transmit one target texture of the target textures that corresponds to the virtual scene picture to the target application using the dynamic link library, the one target texture being configured for triggering the target application to render the one target
texture based on the pose information, to obtain the texture data.

17. The electronic device according to claim 14, wherein the processor is further configured to execute the computer-executable instructions or the computer program to, when determining the rendering start time:
determine a rendering frame rate of the target application using the dynamic link library; and
determine the rendering start time based on the rendering frame rate using the dynamic link library.

18. The electronic device according to claim 17, wherein the processor is further configured to execute the computer-executable instructions or the computer program to, when determining the rendering start time based on the rendering frame rate:
record, in response to ending of rendering of an i^{th} frame of virtual scene picture, rendering end time of the i^{th} frame of virtual scene picture using the dynamic link library, i being an integer greater than 0; and
determine rendering start time of an (i+1)^{th} frame of virtual scene picture based on the rendering frame rate and the rendering end time of the i^{th} frame of virtual scene picture using the dynamic link library.

19. The electronic device according to claim 12, wherein:
the plurality of streaming manners include a first streaming manner and a second streaming manner; and
the processor is further configured to execute the computer-executable instructions or the computer program to, when obtaining the texture data:
obtain, in response to the target streaming manner being the second streaming manner, the texture data of the virtual scene picture of the target application through a streaming process corresponding to the second streaming manner.

20. A non-transitory computer-readable storage medium storing computer-executable instructions or a computer program that, when executed by a processor, causes an electronic device including the processor to:
obtain texture data of a virtual scene picture of a target application based on a target streaming manner selected from a plurality of streaming manners, the target application being configured to render the virtual scene picture;
encode the texture data to obtain a texture encoding result; and
transmit the texture encoding result to a head mounted display device, the texture encoding result being configured for triggering the head mounted display device to decode the texture encoding result to obtain the texture data, and display the virtual scene picture based on the texture data.
